(19) United States
(12) Patent Application Publication
(10) Pub. No.: US 2012/0143577 A1
(43) Pub. Date: Jun. 7, 2012

(54) PRIORITIZING WELL DRILLING PROPOSITIONS

(76) Inventors: MATTHEW SZYNDEL, ABINGDON (GB); JONATHAN A. HOLMES, READING (GB)

(21) Appl. No.: 13/303,957

(22) Filed: Nov. 23, 2011

Related U.S. Application Data
(60) Provisional application No. 61/418,910, filed on Dec. 2, 2010.
(60) Provisional application No. 61/420,836, filed on Dec. 8, 2010.

(51) Int. Cl. G06G 7/48

(52) U.S. Cl. 703/10

(57) ABSTRACT

Embodiments of the present disclosure include one or more of a method, computing device, computer-readable medium, and system for prioritizing drilling propositions. An example embodiment of the present disclosure may include a method that includes providing a reservoir simulator for simulating a reservoir model, wherein the reservoir model defines a plurality of wells to be drilled. The method may further include storing model state information related to the reservoir model; calculating a potential production of at least a portion of the wells to be drilled by simulating one or more timesteps; and restoring the model state information to the reservoir model. In addition, the method may include using the reservoir simulator to simulate the reservoir model with a drilling priority, wherein the drilling priority is based on the calculated potential production.

### CROSS-REFERENCE TO RELATED APPLICATIONS

This application claims the benefit of U.S. Provisional Patent Application 61/418,910 filed Dec. 2, 2010, entitled “Prioritizing Well Drilling Propositions,” the entirety of which is incorporated by reference herein; and U.S. Provisional Patent Application 61/420,836 filed Dec. 8, 2010 entitled “Prioritizing Well Drilling Propositions,” the entirety of which is incorporated by reference herein.

### BACKGROUND

Models of reservoirs and oil well behavior may be used in the formulation of methods to increase yields from oil wells. In addition, models of reservoirs and oil well behavior can also be used to formulate methods to accelerate and/or enhance production from oil wells.

### SUMMARY

Embodiments of the present disclosure may include one or more of a method, computing device, computer-readable medium and system for prioritizing well drilling propositions. An example embodiment of the present disclosure may include a method that includes providing a reservoir simulator for simulating a reservoir model, wherein the reservoir model defines a plurality of wells to be drilled. The method may further include storing model state information related to the reservoir model; calculating a potential production of at least a portion of the wells to be drilled by simulating one or more timesteps; and restoring the model state information to the reservoir model. In addition, the method may include using the reservoir simulator to simulate the reservoir model with a drilling priority, wherein the drilling priority is based on the calculated potential production.

### BRIEF DESCRIPTION OF THE DRAWINGS

Implementations of various technologies will hereafter be described with reference to the accompanying drawings. It should be understood, however, that the accompanying drawings illustrate the various implementations described herein and are not meant to limit the scope of various technologies described herein. The same numbers are used throughout the drawings to reference like features and components.

FIG. 1 illustrates an example method for prioritizing drilling priorities according to an embodiment of the present disclosure, wherein the priorities may be calculated at predetermined intervals.

FIG. 2 illustrates an example method for prioritizing drilling priorities according to an embodiment of the present disclosure, wherein the drilling priorities may be calculated on a “just-in-time” basis.

FIG. 3 illustrates an example method for calculating drilling priorities according to an embodiment of the present disclosure.

FIG. 4 illustrates a computer system that may be used to execute software containing instructions to implement example embodiments according to the present disclosure.

### DETAILED DESCRIPTION

In a possible implementation, a method for prioritizing well drilling propositions may use a description of the oil or gas reservoir (e.g., a numerical description) within a computer software program, such as a “reservoir simulator.” Examples of a reservoir simulator include, without limitation, ECLIPSE® reservoir simulation software (Schlumberger Limited, Houston, Tex.) (referred to herein as “ECLIPSE®”), and INTERSECT® reservoir simulation software (Schlumberger Limited, Houston, Tex.; Chevron, Houston, Tex.).

A reservoir simulator may advance the model of a reservoir through time, taking account of the movement of the fluids within the reservoir and the production and injection of fluids through the wells. When the numerical model of the reservoir has insufficient production capacity to continue producing oil or gas at a desired target rate through a set of open wells, the reservoir simulator may initiate the process of drilling and opening a new well in the numerical model. For example, the new well can be selected as a “target candidate” for drilling from a list of wells at different locations within the reservoir provided as input data by the reservoir engineer (this list may be referred to herein as the “drilling queue”).

In a possible embodiment, as part of identifying a target candidate well from the drilling queue, the wells can be ranked in order of priority, where the priority of a well may be determined from a formula. As an example, formula variables may include, without limitation, the potential oil, water, and gas rates that the well would produce if it were opened.

In an example embodiment of a method of prioritizing well drilling propositions, a “look-ahead” procedure may be carried out to determine a potential production rate, and hence the drilling priority, of each well. An example method may take into account changes of behavior related to the well within the simulation model over a specified period of time.

When a look-ahead calculation is used, the reservoir simulator may save the current state of the model (e.g., in its memory or to disk) and may advance the model over a specified period of time to determine how the production rates of the candidate wells in the drilling queue may evolve over this period. Upon performing this calculation to obtain the production rates over this period, the reservoir simulator may select a target well to drill. It may return to the beginning of the look-ahead calculation, restore the saved state of the reservoir model, restart the simulation at this time, and instigate the drilling of the selected well according to the reservoir simulation model.

An example embodiment of prioritizing well drilling propositions within a reservoir simulator may include adding a facility to save the model state whenever a look-ahead calculation is used. The state of the simulation model can be stored, including the current values of the solution variables for the reservoir grid cells and the wells. A restore facility can also be implemented, which allows the model to be reset to its state immediately before the look-ahead calculation so that the simulation can be advanced through time from this point.

In ECLIPSE® software, there is a “DRILPRI” keyword. This keyword may be used to set the coefficients that define the default priority formula for a prioritized drilling queue. It may be used if any wells are placed in a queue without a fixed priority set. Wells may be opened from the drilling queue whenever they are needed to maintain a group rate target under group control by guide rate. They may also be opened from the drilling queue should they be needed to maintain a group's production potential.

A drilling queue may either be a sequential drilling queue, or a prioritized drilling queue. In a sequential drilling queue, wells are opened in the sequence in which they were placed in the queue. In a prioritized drilling queue, wells may be opened in decreasing order of their drilling priority. In a reservoir simulator, the order of opening, however, may be affected by the availability of drilling rigs. For example, if there is no drilling rig available for the well with the highest drilling priority a well with a lower drilling priority may be opened instead.

For production wells, the drilling priorities may be calculated from a formula. The following Equation 1 is an example formula (Equation 1 is the formula currently applied in ECLIPSE® software):

$$P = \frac{A + {BQ}_{o} + {CQ}_{w} + {DQ}_{g}}{E + {FQ}_{o} + {GQ}_{w} + {HQ}_{g}} \qquad ( Equation 1 )$$

In Equation 1 above, P is the drilling priority, A-H are user defined coefficients, Qo is the potential oil production rate, Qw is the potential water production rate and Qg is the potential gas production rate. The user of the simulation can provide values for the coefficients A-H. According to other embodiments, other formulas may be used instead of Equation 1.

Equation 1 allows the drilling priority to be set equal to, for example, the potential oil rate, or the reciprocal of the potential gas rate, or the reciprocal of the water cut. For injection wells, the drilling priorities are set equal to their potential injection rates. Individual wells may have their calculated priorities replaced by fixed values input, if required.

The drilling priority of a well may be based on the instantaneous production potential of that well. However, according to another embodiment, a reservoir simulator may perform a “look-ahead” calculation. A look-ahead calculation may include saving the model state and running wells in the prioritized drilling queue for a period of time before calculating their priority. After these calculations the model may be reset. This potentially gives a better idea of the eventual running state of the well.

Further to the example embodiment discussed above, a user may be asked to define a look-ahead period. This is the period of time for which the simulation model can be advanced to establish the behavior of candidate wells in order to calculate their drilling priorities. The user may also be allowed to specify a predetermined interval at which regular look-ahead calculations are performed during the simulation to update the drilling priorities of the wells in the drilling queue. According to another embodiment, the reservoir simulation software may recommend, or automatically define, the predetermined interval.

If no look-ahead period is defined, then drilling priorities may be calculated using the potential rates of each well at the time of calculation. However, if a look-ahead period is defined, then a reservoir simulator may save the model state, open one or more wells and run forward for this period before calculating the potentials to make the drilling priority calculation. The model may then be restored to the condition at the start of the drilling priority calculation once all well drilling priorities have been calculated.

A reservoir simulator may allow a “look-ahead calculation type” to be defined. In an example embodiment, if the look-ahead calculation type may be set to a first type (e.g., “SINGLE”), then the model state may be run forward once for each well placed in the drilling queue, with one well opened and one drilling priority calculated per run forward. As another example, if the look-ahead calculation type is set to a second type (e.g., “ALL”), then all applicable wells may be opened and have their drilling priority calculated at once. In certain cases, “SINGLE” may give better results while “ALL” may run more quickly, as it involves fewer save, run, restore cycles.

One benefit of a look-ahead calculation is that it may allow an engineer to determine the best-available well if the initial flowing conditions are not likely to persist. This may be because water coning is likely to give a high water cut a short period after a well is opened, or it may be because an initial period of water production is expected from a coal bed methane development. In certain circumstances, if the look-ahead period is set to a large value and the recalculation interval is set to a small interval then there will be significant performance implications.

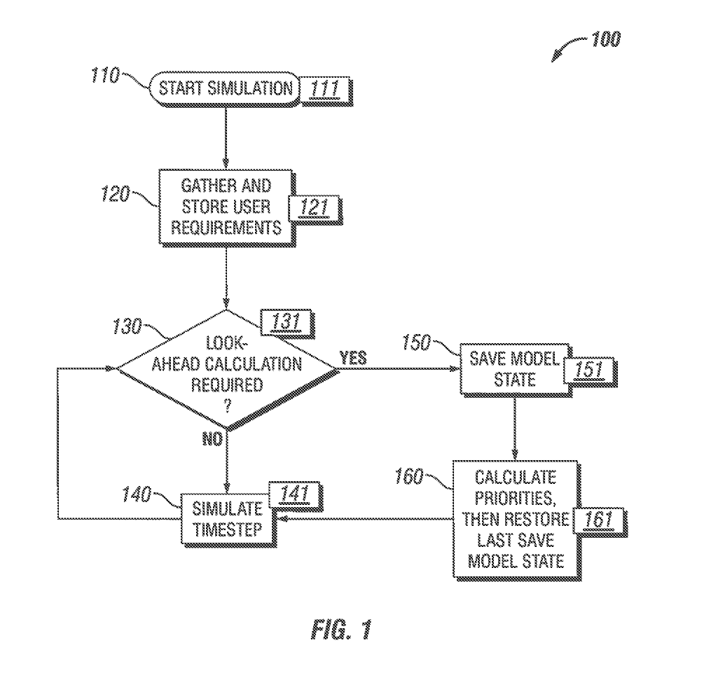

FIG. 1 illustrates an example method 100 in which drilling priorities may be recalculated at predetermined intervals. Method 100 may include starting a simulation at block 110. Block 120 may include gathering and storing user requirements. Block 130 may include determining whether a look-ahead calculation should take place (i.e., does the current timestep include the predetermined interval). If the current timestep does not include the predetermined interval, then the current timestep may be simulated at block 140, and the method 100 loops back to block 130. However, if the current timestep includes the predetermined interval, then method 100 may proceed to block 150, where the model state may be saved. At block 160, well drilling priorities may be calculated, and the saved model state may be restored. The method 100 may proceed to block 140, where the timestep may be simulated using the restored saved model state.

The method 100 is shown in FIG. 1 in association with various computer-readable media (CRM) blocks 111, 121, 131, 141, 151, and 161. Such blocks generally include instructions suitable for execution by one or more processors (or cores) to instruct a computing device or system to perform one or more actions. While various blocks are shown, a single medium may be configured with instructions to allow for, at least in part, performance of various actions of the method 100.

As an example, one or more computer-readable media can include computer-executable instructions to instruct a computing device to provide finite elements described with respect to starting a simulation at CRM 111. CRM 121 may include gathering and storing user requirements. CRM 131 may include determining whether a look-ahead calculation should take place (i.e., does the current timestep include the predetermined interval). If the current timestep does not include the predetermined interval, then the current timestep may be simulated at CRM 141, and the instructions may loop back to CRM 131. However, if the current timestep includes the predetermined interval, then the instructions may proceed to CRM 151, where the model state may be saved. At CRM 161, well drilling priorities may be calculated, and the saved model state may be restored. The instructions may proceed to CRM 141, where the timestep may be simulated using the restored saved model state.

In another embodiment, the simulator may calculate well drilling priorities “just in time” (e.g., when a new well is required to be drilled). For example, at the start of each simulation timestep, the reservoir simulation software may establish whether or not a look-ahead calculation fits a predetermined criterion or set of criteria. In an embodiment where a “just-in-time” calculation is used, the reservoir simulator could simulate the next timestep, in order to establish whether or not a drilling event will take place, and then restore the beginning-of-timestep conditions to allow the look-ahead calculation to proceed if a drilling event should occur.

If a look-ahead calculation is used, the reservoir simulation software may save the model state. The reservoir simulator can then open one, some, or all of the candidate wells in the drilling queue and advance the simulation over the look-ahead period. At the end of the period, the reservoir simulator may calculate the drilling priorities of the candidate wells that were opened. The reservoir simulator can also reset the simulation state to the beginning of the look-ahead period using the restore facility described above. This procedure can either be repeated (e.g., opening and testing each candidate well individually or opening groups of two or more candidate wells together), or it can be carried out once only with all the candidate wells opened together.

In an example embodiment, the reservoir simulator may be programmed so that during the above process, care is exercised to avoid triggering a look-ahead calculation if a calculation is already in progress. For example, the reservoir simulator may be programmed to ensure that another “just-in-time” priority calculation is not triggered if one has already been performed for the same simulation timestep.

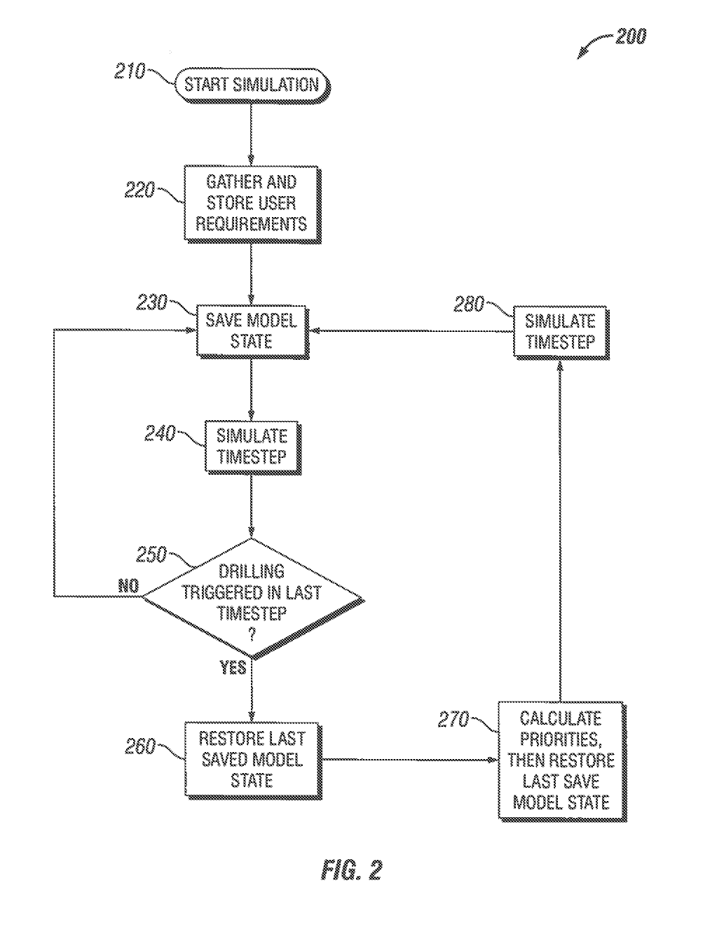

FIG. 2 illustrates an example method 200 in which drilling priorities are calculated on a “just-in-time” basis. According to an example embodiment, method 200 may include starting simulation at block 210. Block 220 may include gathering and storing user requirements. At block 230, model state may be saved, and a timestep may be simulated at block 240. A determination of whether drilling was triggered in a last (or previous) timestep may be performed at block 250. If drilling was not triggered in a last/previous timestep, then the method 200 may loop back to 230.

However, if drilling was triggered in the last/previous timestep, then the method may proceed to block 260. At block 260, saved model information may be restored. Block 270 may include calculating well drilling priorities, as described herein, and restoring saved model state. Method 200 may proceed to block 280, at which the timestep may be simulated again, opening a well using the drilling priorities calculated at block 270. Upon performing block 280, the method 200 may loop back to block 230.

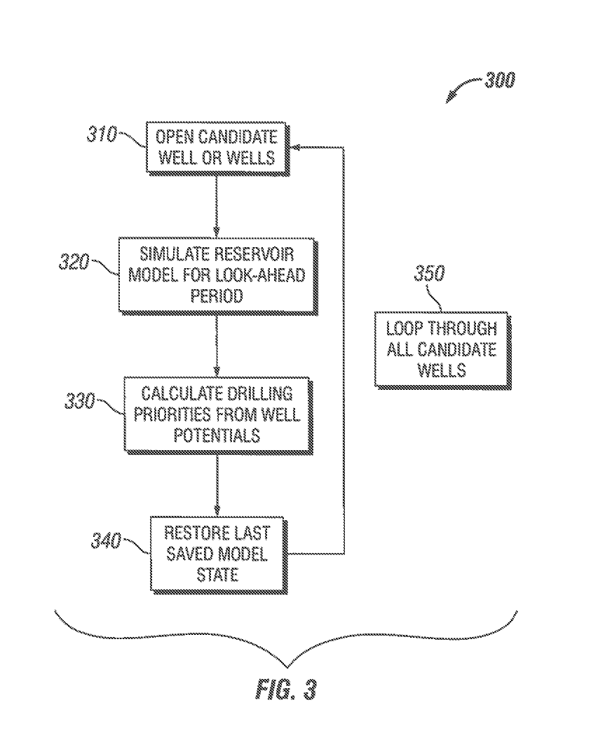

FIG. 3 illustrates a method 300 of calculating drilling priorities in blocks 160 or 270 as described above according to an embodiment of the present disclosure. Method 300 may include opening one or more candidate well(s) at block 310. Block 320 may include simulating a reservoir model for a look-ahead period. Drilling priorities based upon well potentials may be calculated at block 330. At block 340, saved model state may be restored. The method 300 may include a block 350 that includes looping through blocks 310-340 for at least a portion of all candidate wells (e.g., in an example embodiment, block 350 may loop through blocks 310-340 for all candidate wells).

Various aspects of the example embodiments disclosed herein may be customized for specific use cases. For example, in an example embodiment the reservoir model may include a coal bed methane (CBM) model. In another example embodiment, the simulator may calculate well drilling priorities in response to a drilling request. In yet another example embodiment, it may be advantageous in certain situations to base the allocation of well production targets on look-ahead potentials, rather than instantaneous potentials. Example embodiments disclosed herein may be adapted to support such applications.

### Computer System for Oilfield Application System

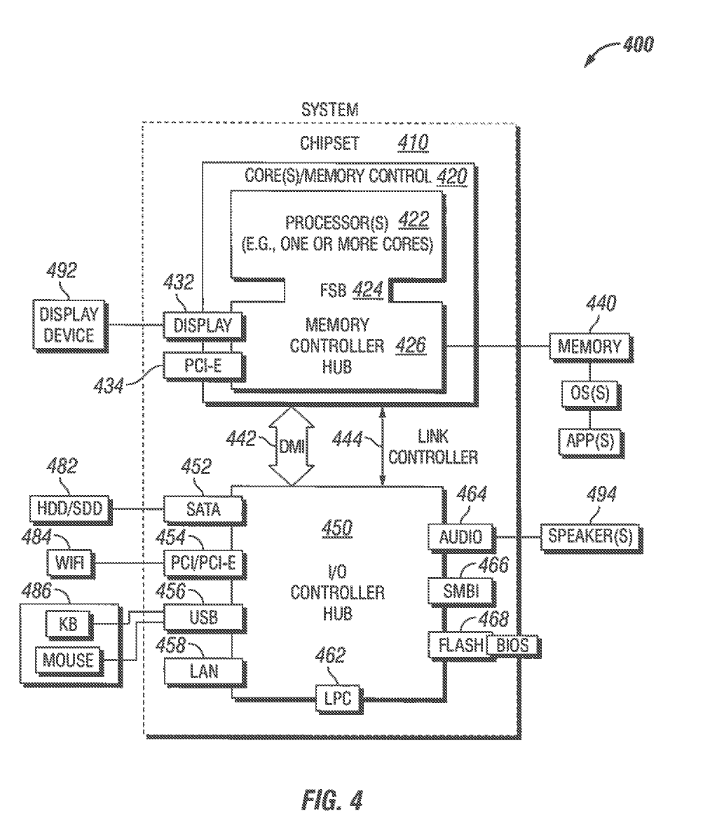

FIG. 4 shows a system 400 that may be used to execute software containing instructions to implement example embodiments according to the present disclosure. The system 400 of FIG. 4 may include a chipset 410 that includes a core and memory control group 420 and an I/O controller hub 450 that exchange information (e.g., data, signals, commands, etc.) via a direct management interface (e.g., DMI, a chip-to-chip interface) 442 or a link controller 444. The core and memory control group 420 include one or more processors 422 (e.g., each with one or more cores) and a memory controller hub 426 that exchange information via a front side bus (FSB) 424 (e.g., optionally in an integrated architecture). The memory controller hub 426 interfaces with memory 440 (e.g., RAM “system memory”). The memory controller hub 426 further includes a display interface 432 for a display device 492. The memory controller hub 426 also includes a PCI-express interface (PCI-E) 434 (e.g., for graphics support).

In FIG. 4, the I/O hub controller 450 includes a SATA interface 452 (e.g., for HDDs, SDDs, etc., 482), a PCI-E interface 454 (e.g., for wireless connections 484), a USB interface 456 (e.g., for input devices 486 such as keyboard, mice, cameras, phones, storage, etc.), a network interface 458 (e.g., LAN), a LPC interface 462 (e.g., for ROM, I/O, other memory), an audio interface 464 (e.g., for speakers 494), a system management bus interface 466 (e.g., SM/I2C, etc.), and Flash 468 (e.g., for BIOS). The I/O hub controller 150 may include gigabit Ethernet support.

The system 400, upon power on, may be configured to execute boot code for BIOS and thereafter processes data under the control of one or more operating systems and application software (e.g., stored in memory 440). An operating system may be stored in any of a variety of locations. A device may include fewer or more features than shown in the example system 400 of FIG. 4.

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A method, comprising;
providing a reservoir simulator for simulating a reservoir model, wherein the reservoir model defines a plurality of wells to be drilled;
storing model state information related to the reservoir model;
calculating a potential production of at least a portion of the wells to be drilled by simulating one or more timesteps;
restoring the model state information to the reservoir model; and
using the reservoir simulator to simulate the reservoir model with a drilling priority, wherein the drilling priority is based on the calculated potential production.

2. The method of claim 1, wherein storing model state information occurs after simulation of a first timestep, and wherein the one or more timesteps comprise a second timestep that represents a time period after the first timestep.

3. The method of claim 1, wherein the well to be drilled comprises a plurality of wells to be drilled, and further comprising:
identifying a target candidate well among the plurality of wells to be drilled; and
wherein using the reservoir simulator to simulate the reservoir model with the drilling priority comprises simulating drilling of the target candidate.

4. The method of claim 1, wherein the calculating occurs at a predetermined time interval.

5. The method of claim 1, wherein the calculating occurs only if a result of simulating a second one or more timesteps produces a predetermined result.

6. The method of claim 5, wherein the predetermined result comprises drilling a new well.

7. The method of claim 1, further comprising using the potential production to allocate a well production target defined by the reservoir model.

8. One or more computer-readable media comprising computer-executable instructions to instruct a computing device to perform a process, the process comprising:
providing a reservoir simulator for simulating a reservoir model, wherein the reservoir model defines a plurality of wells to be drilled;
storing model state information related to the reservoir model;
calculating a potential production of at least a portion of the wells to be drilled by simulating one or more timesteps;
restoring the model state information to the reservoir model; and
using the reservoir simulator to simulate the reservoir model with a drilling priority, wherein the drilling priority is based on the calculated potential production.

9. The computer-readable media of claim 8, wherein storing model state information occurs after simulation of a first timestep, and wherein the one or more timesteps comprise a second timestep that represents a time period after the first timestep.

10. The computer-readable media of claim 8, wherein the well to be drilled comprises a plurality of wells to be drilled, and wherein the process further comprises:
identifying a target candidate well among the plurality of wells to be drilled; and
wherein using the reservoir simulator to simulate the reservoir model with the drilling priority comprises simulating drilling of the target candidate.

11. The computer-readable media of claim 8, wherein the calculating occurs at a predetermined time interval.

12. The computer-readable media of claim 8, wherein the calculating occurs only if a result of simulating a second one or more timesteps produces a predetermined result.

13. The computer-readable media of claim 12, wherein the predetermined result comprises drilling a new well.

14. The computer-readable media of claim 8, wherein the process further comprises using the potential production to allocate a well production target defined by the reservoir model.

15. A system, comprising:
a processor;
a memory;
a storage medium;
a plurality of computer-executable instructions residing in the storage medium to instruct the processor to perform a process, the process comprising:
providing a reservoir simulator for simulating a reservoir model, wherein the reservoir model defines a plurality of wells to be drilled;
storing model state information related to the reservoir model;
calculating a potential production of at least a portion of the wells to be drilled by simulating one or more timesteps;
restoring the model state information to the reservoir model; and
using the reservoir simulator to simulate the reservoir model with a drilling priority, wherein the drilling priority is based on the calculated potential production.

16. The system of claim 15, wherein storing model state information occurs after simulation of a first timestep, and wherein the one or more timesteps comprise a second timestep that represents a time period after the first timestep.

17. The system of claim 15, wherein the well to be drilled comprises a plurality of wells to be drilled, and wherein the process further comprises:
identifying a target candidate well among the plurality of wells to be drilled; and
wherein using the reservoir simulator to simulate the reservoir model with the drilling priority comprises simulating drilling of the target candidate.

18. The system of claim 15, wherein the calculating occurs only if a result of simulating a second one or more timesteps produces a predetermined result.

19. The system of claim 18, wherein the predetermined result comprises drilling a new well.

20. The system of claim 15, wherein the process further comprises using the potential production to allocate a well production target defined by the reservoir model.
